(19) United States
(12) Patent Application Publication
(10) Pub. No.: US 2004/0201884 A1
(43) Pub. Date: Oct. 14, 2004

(54) Microscope having an illumination system

(76) Inventors: Jacques Alain Deverin, Widnau (CH); Olivier Deverin, (US)

Correspondence Address: HODGSON RUSS LLP, ONE M & T PLAZA, SUITE 2000, BUFFALO, NY, 14203-2391, US

(21) Appl. No.: 10/764,315

(22) Filed: Jan. 23, 2004

(30) Foreign Application Priority Data
Jan. 31, 2003 (DE) 103 03 825.6

(51) Int. Cl. G02B 21/06

(52) U.S. Cl. 359/385; 359/368

(57) ABSTRACT

The invention concerns a stereomicroscope having a doubled, symmetrically arranged UV illumination device (20a, 20b), the illumination beam paths (10a, 10b) being guided by a deflection arrangement (21) comprising a deflection prism (5) for the illumination beam path (3) of a conventional illumination system (19) and two symmetrically arranged deflection elements (12a, b) for the illumination beam paths (10a, 10b) of the doubled UV illumination device (20a, 20b).

### CROSS REFERENCE TO RELATED APPLICATIONS

This application claims priority of the German patent application 103 03 825.6 filed Jan. 31, 2003 which is incorporated by reference herein.

### FIELD OF THE INVENTION

The invention concerns a microscope having an illumination system. The invention deals in particular with fluorescence illumination system (UV illumination system) for a stereomicroscope. “Fluorescence illumination” is understood to mean illumination by means of a light in the ultraviolet wavelength region, resulting in expanded observation and analysis capabilities with so-called fluorescence observation of the specimen being viewed.

### BACKGROUND OF THE INVENTION

Those skilled in the art are familiar principally with UV illumination units that are arranged laterally and obliquely on the microscope body, or above it. The substantial disadvantages of such arrangements are, however, that such illumination units require a great deal of space, and further that the illumination occurs obliquely—in any event not coaxially with the main beam path or paths of the microscope (corresponding to the optical axis of the microscope)—and thus produces an inhomogeneous illumination field that forms “shadows.”

Illumination units that are reflected in sideways, by means of deflection elements positioned beneath the main objective, have therefore been created. Thanks to good coaxial alignment with the main beam path of the microscope, these arrangements are capable of yielding a homogeneously illuminated viewing field. A disadvantage here, however, is that the working distance—i.e. the distance between the lowest part of the microscope and the specimen—is unacceptably reduced by the space occupied by the laterally arranged illumination units and most of all by the deflection elements beneath the main objective.

A solution that is improved in this regard has already been presented in DE-A1-197 39 428. Here the deflection of the illuminating beam path is accomplished by means of a deflection mirror that is arranged above or at the level of the main objective, and that directs the illumination beam through an opening in the main objective. A “meniscus” (i.e. an additional optical element having positive focal power) and a filter are provided below the main objective in a manner allowing them to be pivoted in. This makes possible approximately coaxial illumination with less of a negative influence on the working distance. The disadvantages that remain, however, are the complex embodiment of the main objective and an illumination that is still one-sided, with the possibility of shadowing.

### SUMMARY OF THE INVENTION

The object that presented itself to the inventor was therefore that of discovering an improved UV illumination system that no longer exhibits the aforesaid disadvantages. The new type of illumination was also intended to be usable in the same way for other light sources, and to provide improvements in that context as well.

This object is achieved by the use of two illumination beam paths that are directed through a combined deflection element of a conventional illumination system. For this, two deflection elements are mounted laterally (preferably symmetrically) on the deflection prism of the normal coaxial illumination system. The advantage of a conventional coaxial illumination is thus retained, without reducing the working distance. In addition, the provision of two additional illumination beam paths guarantees not only stronger illumination, but also substantially more homogeneous illumination. This is based on the fact that good coaxiality of all the illumination beams with respect to the optical axis of the microscope is implemented, and additionally that for each pupil a separate illumination beam (i.e. preferably the respective oppositely located one) is available at an optimum return angle. This is optimized when the two illumination beam paths are arranged symmetrically.

The two deflection elements arranged, preferably symmetrically, on the deflection prism of a conventional illumination system can be mirrors or prisms having a mirror-coated cemented surface. The mirrors can be a plane mirror or also a concave mirror having refractive (focal) power. The prisms can be simple prisms without refractive power. They can also comprise one or more surfaces having refractive power.

In the preferred embodiments of the deflection element as an optical element having refractive power, the deflection element acts as a field lens that makes possible imaging of a field diaphragm of the UV illumination system by the main objective. Better delimitation of the illuminated field on the specimen is thereby achieved (Köhler illumination).

In addition, however, those variant embodiments of the invention in which the deflection elements themselves have no refractive power also fall within the disclosure context of the Application. In this case the objective and/or other additional optical elements ensure optimum projection into the object plane.

In a preferred embodiment, the angle between the optical axis of the main illumination and that of the laterally arranged illumination beam paths is approximately 90 degrees; other arrangements are, however, likewise within the context of the disclosure of this Application.

Light sources for purposes of this Application may also be individual light guides or fiber bundles or individual fibers that originally derive from a single illumination source, since the multiple introduction locations of the light are essential to the invention.

Further embodiments of the invention are described in the Figures and in the dependent claims. The Parts List is a constituent of the disclosure.

### BRIEF DESCRIPTION OF THE DRAWINGS

The invention will be described in more detail, symbolically and by way of example, with reference to schematic Figures. The Figures are described in continuous and overlapping fashion. Identical reference characters denote identical components; reference characters having different indices indicate functionally identical components. In the drawings:

FIG. 1a shows in plan view the configuration of a known illumination device for a stereomicroscope;

FIG. 1b shows the configuration of FIG. 1a in a side view;

FIG. 2a shows in plan view a configuration according to the present invention, having a combined deflection arrangement and two lateral UV illumination arrangements;

FIG. 2b shows the arrangement of FIG. 2a in a side view;

FIG. 2c shows the arrangement of FIGS. 2a and 2b as viewed from the direction of light source 2, the deflection elements being depicted larger, and mirrors being used as deflection elements; and

FIG. 3 shows the arrangement of FIGS. 2a and 2b as viewed from the direction of light source 2, prisms being arranged as deflection elements instead of the mirrors.

### DETAILED DESCRIPTION OF THE INVENTION

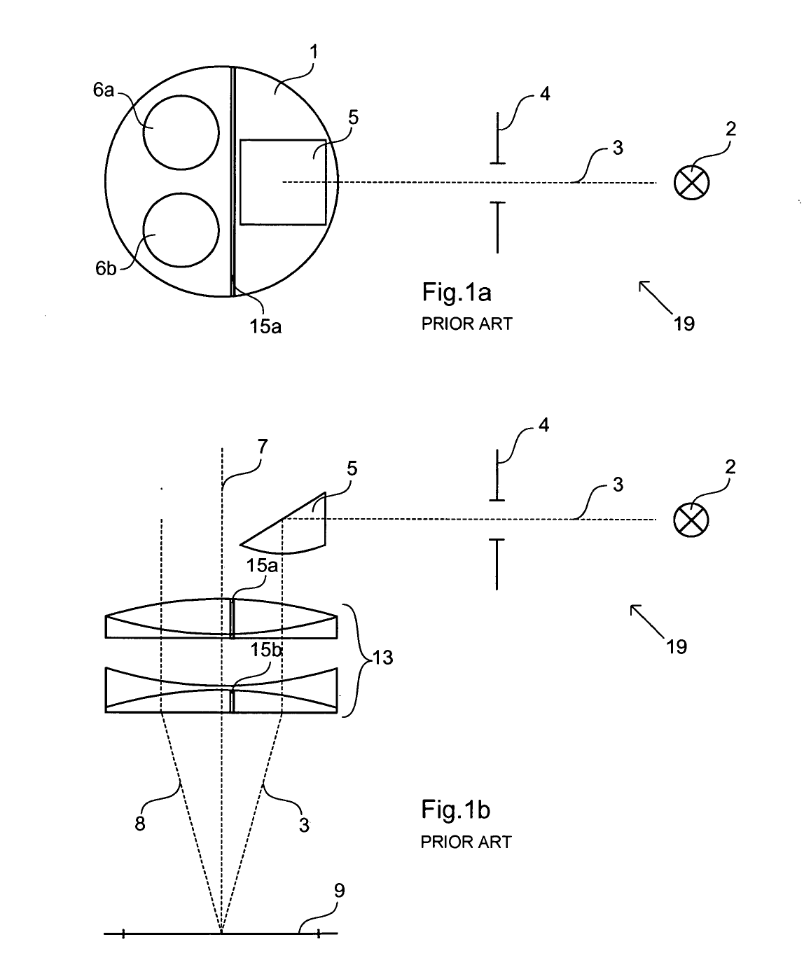

FIGS. 1a and 1b depict the configuration of an illumination apparatus for a stereomicroscope in order to illustrate the existing art, a microscope body 1 being depicted in plan view and in section. It is apparent that microscope body 1 is separated by partition 15a into a part in which microscope pupils 6a and 6b are arranged, and a part where deflection prism 5 is arranged. The illumination beam path, depicted by optical axis 3, is generated by light source 2, and an image of field diaphragm 4 is projected by means of deflection prism 5 and main objective ensemble 13 onto object field 9.

It is evident that for the purpose of better definition of the illuminated field, deflection prism 5 is equipped with refractive power. As a result, deflection element 5 acts as a field lens that allows field diaphragm 4 to be imaged by main objective ensemble 13. The illumination beam path, represented by optical axis 3, is aligned onto the center of object field 9, which at the same time lies on the optical axis of main objective ensemble 13. From there, the illumination beam path (represented by optical axis 3) is received by the observation beam path (represented by optical axis 8 of the microscope) and guided through microscope pupils 6a and 6b (no longer depicted).

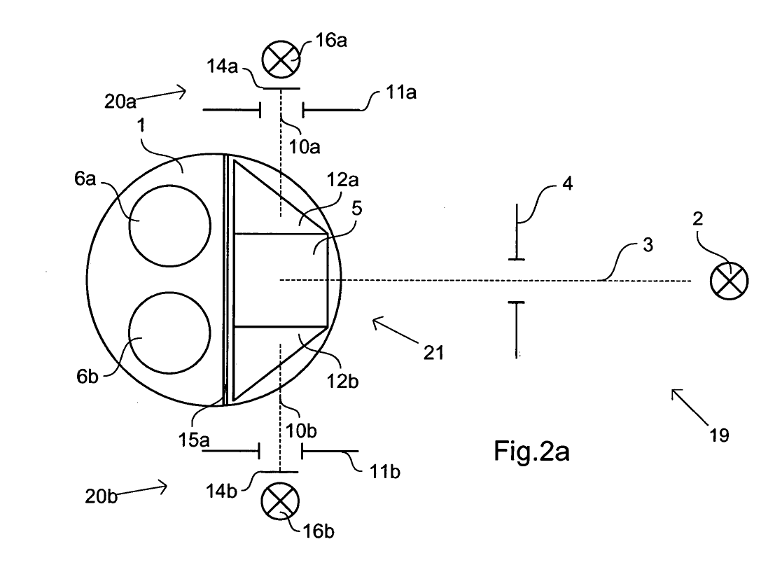

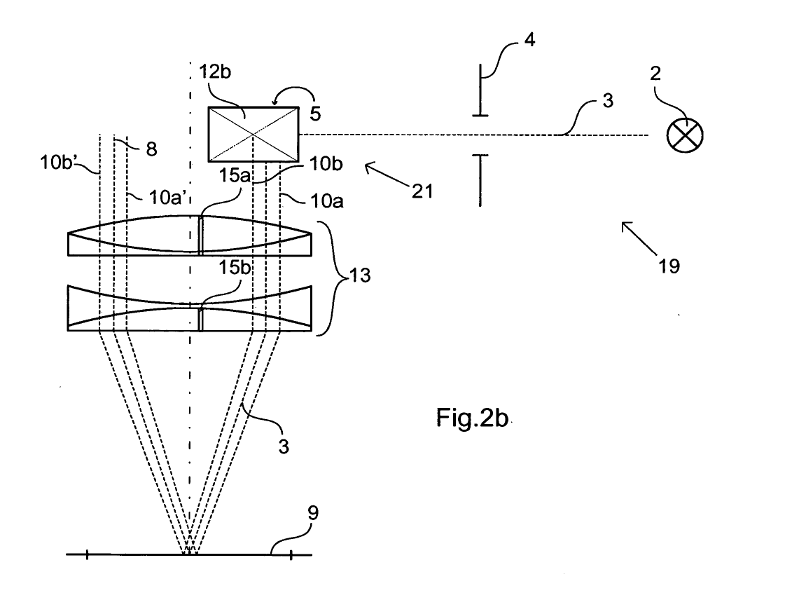

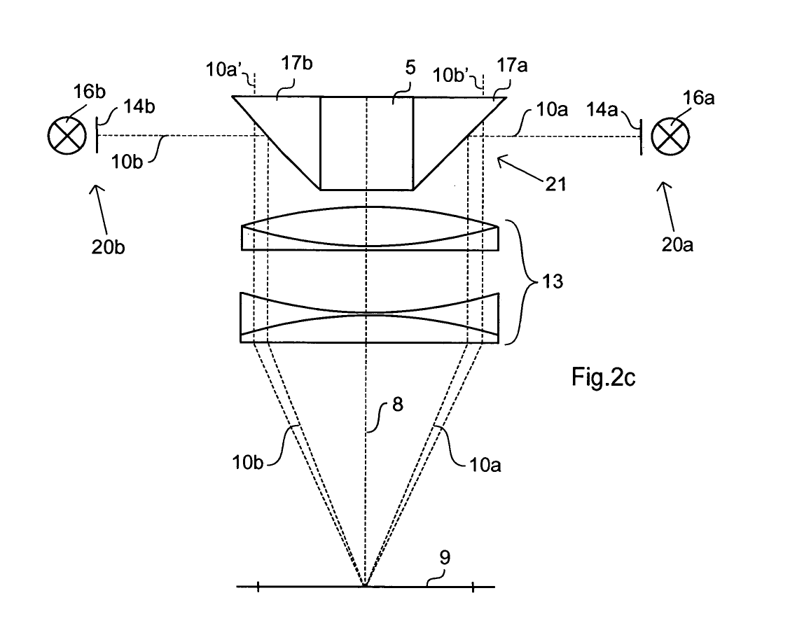

FIG. 2a shows manner in which a UV illumination arrangement according to the present invention is constructed. Provided here, in addition to the conventional illumination system as shown in FIGS. 1a and 1b, are two laterally arranged illumination systems 16a and 16b from which the non-UV wavelength region is blocked by means of filters 14a and 14b, respectively. The UV illumination beam path thereby produced—represented by optical axes 10a and 10b, respectively—passes through the respective iris diaphragms 11a and 11b and is deflected by respective deflection elements 12a and 12b onto object field 9 (not depicted in this view).

FIG. 2b is a side view of the configuration presented in FIG. 2a, and does not depict the laterally arranged UV illumination systems 16. For better elucidation, the corresponding beam paths 10a and 10b are depicted next to one another, although they are collimated and (in this side view) superimposed on one another.

FIG. 2c is a view, rotated 90 degrees to the right, of the configuration shown in FIG. 2b; in other words, the configuration is viewed from the direction of optical axis 3 of illumination device 19 (not depicted here) with normal illumination. It is evident here that deflection elements 17a and 17b are embodied symmetrically as mirrors for the deflection of beam paths 10a and 10b of UV illumination devices 20a and 20b, respectively. It is also evident from this viewing angle that right-hand illumination beam path 10a, constituting reflected observation beam path 10a′, can optimally coaxially supply the oppositely located microscope pupil 6b (not depictable here; cf. FIG. 2a). The same is true, vice versa, of illumination beam path 10b. As a result of their shape that is clipped for space reasons, the deflection elements have an extension similar to that of a pyramid.

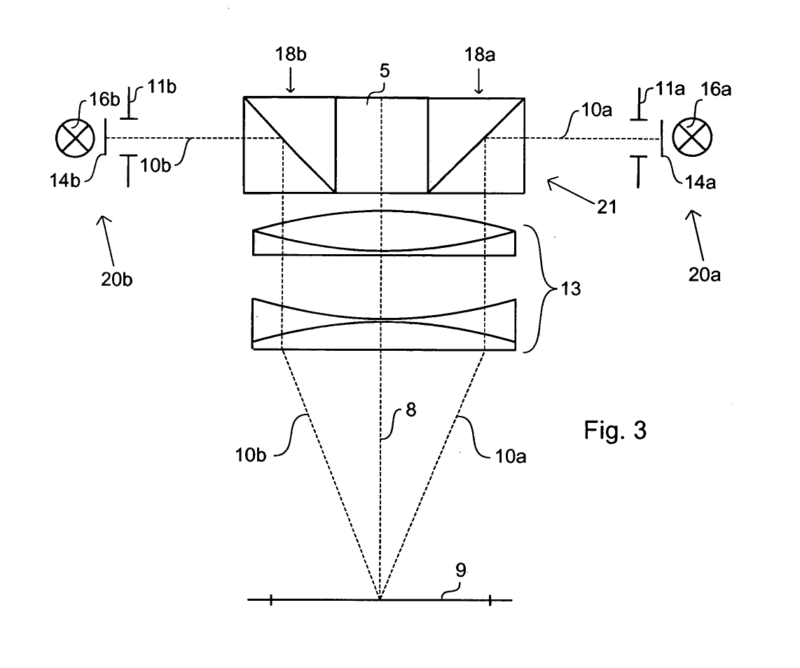

FIG. 3 presents a variant embodiment with prisms 18a, b having refractive power, and consequently also with iris diaphragms 11a, b.

The present invention can also be embodied in a microscope having transmitted specimen illumination, wherein the deflection elements and illumination beam paths are arranged below a specimen carrier of the microscope such that the illumination beams travel upward and light is transmitted through the specimen to the microscope objective.

Parts List

1 Microscope body

2 Light source for conventional illumination

3 Optical axis of conventional illumination

4 Field diaphragm for conventional illumination

5 Deflection prism having refractive power

6a, b Microscope pupil(s)

7 Optical axis of main objective

8 Optical axis of microscope

9 Object field

10a, b Optical axis/axes of UV illumination

10a′, b′ Optical axis/axes of reflected observation beam path

11a, b Iris diaphragm(s)

12a, b Deflection element(s)

13 Main objective ensemble

14a, b Filter(s)

15a, b Partition(s)

16a, b UV illumination light source(s)

17a, b Mirror(s)

18a, b Prism(s) having refractive power

19 Illumination device for conventional illumination

20a, b UV illumination device(s)

21 Composite deflection element

What is claimed is:

1. A microscope comprising:
a first illumination device (20a) on one side of the microscope for providing a first illumination beam traveling along a first illumination beam path (10a); and
a second illumination device (20b) on another side of the microscope for providing a second illumination beam traveling along a second illumination beam path (10b);
wherein the first illumination beam and the second illumination beam have the same light frequency.

2. The microscope as defined in claim 1, further comprising a third illumination device (19) for providing a third illumination beam traveling along a third illumination beam path (3).

3. The microscope as defined in claim 1, wherein the light frequency of the first and second illumination beams is in the ultra-violet range.

4. The microscope as defined in claim 3, further comprising an optical axis (8), wherein the first and second illumination beam paths (10a, 10b) are aligned coaxially with the optical axis (8) of the microscope.

5. The microscope as defined in claim 4, wherein the first and second illumination devices (20a, 20b) are arranged symmetrically with respect to the optical axis (8).

6. The microscope as defined in claim 2, further comprising a main objective (13), a first deflection element (12a) arranged above the main objective (13) in the first illumination beam path (10a), and a second deflection element (12b) arranged above the main objective (13) in the second illumination beam path (10b).

7. The microscope as defined in claim 6, further comprising a deflection prism (5) in the third illumination beam path (3), wherein the first and second deflection elements (12a, 12b) are arranged at the height of the deflection prism (5).

8. The microscope as defined in claim 6, wherein the first and second deflection elements (12a, 12b) are not parts of a composite deflection element.

9. The microscope as defined in claim 7, wherein the first and second deflection elements (12a, 12b) and the deflection prism (5) are not parts of a composite deflection element.

10. The microscope as defined in claim 7, wherein the first and second deflection elements (12a, 12b) and the deflection prism (5) are parts of a composite deflection element.

11. The microscope as defined in claim 7, wherein at least one of the first and second deflection elements (12a, 12b) and the deflection prism (5) has non-zero focal power.

12. The microscope as defined in claim 7, wherein the first and second deflection elements (12a, 12b) and the deflection prism (5) are replaceable to permit interchange with like elements of chosen focal power.

13. The microscope as defined in claim 1, wherein each of the first and second deflection elements (12a, 12b) is a mirror.

14. The microscope as defined in claim 13, wherein the mirror is a concave mirror (17a, 17b).

15. The microscope as defined in claim 1, wherein each of the first and second deflection elements (12a, 12b) is a prism.

16. The microscope as defined in claim 2, wherein the third illumination beam path (3) and the first illumination beam path (10a) intersect to form an angle of approximately 90 degrees.

17. The microscope as defined in claim 16, wherein the third illumination beam path (3) and the second illumination beam path (10b) intersect to form an angle of approximately 90 degrees.

18. The microscope as defined in claim 2, wherein the third illumination beam path (3) and the first illumination beam path (10a) intersect to form an angle between zero and 180 degrees, and the third illumination beam path (3) and the second illumination beam path (10a) intersect to form an angle between zero and 180 degrees.

19. The microscope as defined in claim 1, wherein the microscope is a stereomicroscope.

20. The microscope as defined in claim 1, wherein the microscope is a surgical microscope.

21. The microscope as defined in claim 1, wherein the first and second illumination beams travel upward to an observed specimen for transmitted illumination of the specimen.
